(19) United States
(12) Patent Application Publication
(10) Pub. No.: US 2007/0290986 A1
(43) Pub. Date: Dec. 20, 2007

(54) Apparatus and method for disabling a user interface

(76) Inventor: Erkki Kurkinen, Puuppola (FI)

Correspondence Address: PERMAN & GREEN, 425 POST ROAD, FAIRFIELD, CT, 06824, US

(21) Appl. No.: 11/471,028

(22) Filed: Jun. 20, 2006

(51) Int. Cl. G09G 5/00

(52) U.S. Cl. 345/156

(57) ABSTRACT

An apparatus including a first user interface and a second user interface and a processor connected to the first and second user interface. The processor being configured to disable at least one feature of the second user interface when a user interface deactivation input is received from the first user interface.

### BACKGROUND

1. Field

The disclosed embodiments relate to communication devices, and more particularly to communication devices with more than one user interface.

2. Brief Description of Related Developments

Communications devices, such as for example mobile or cellular telephones, come in many varieties such as, for example block phones and flip phones. Block phones generally have one user interface that includes a display and a keypad on a front side of the phone and battery access on the back side of the phone. The body or case of the block phone is typically rigid (e.g. the phone does not fold). Certain styles of communication devices can incorporate more than one user interface on the device. For example, a “flip” phone as the term and device are commonly understood, has an upper half and a lower half connected by a hinge that allows the two halves of the phone to be folded up so that the phone becomes a compact unit for carrying.

Conventional flip phones, in addition to a main display, may also have a display on one of the outer covers of the phone to provide a user with information when the phone is in a folded or closed position. User input devices such as for example, buttons or keys may also be provided on the outside cover of the flip phone to allow the user to access certain functions of the device when it is in the folded position. Generally, the main user interface of the flip phone is located on the inside of the phone so that when the phone is opened or unfolded, a keypad and main display screen are available to the user. However, in these conventional flip phones the display and user input devices on the outside cover of the phone cannot be turned off or disabled separately from the main display of the device.

It would be advantageous for a user to be able to turn off the display and disable any user input devices on a secondary user interface of a device separately from the main user interface.

### SUMMARY

In one aspect, the disclosed embodiments are directed to an apparatus including a first user interface and a second user interface is provided. The apparatus also includes a processor connected to the first and second user interface, the processor being configured to disable at least one feature of the second user interface when a user interface deactivation input is received from the first user interface.

In another aspect, the disclosed embodiments are directed to a method to disable a user interface of a device. In one embodiment, the method includes activating a user interface display disable function on a first user interface of a device and disabling a second user interface of the device in response to the activation of the user interface disable function of the first user interface.

In a further aspect, the disclosed embodiments a directed to a computer program product. In one embodiment, the computer program product includes a computer useable medium having computer readable code means embodied therein for causing a computer to disable a user interface of a device. The computer readable code means in the computer program product includes computer readable code means for causing a computer to activate a user interface display disable function on a first user interface of the device and computer readable code means for causing a computer to disable a second user interface of the device in response to the activation of the user interface disable function of the first user interface.

### BRIEF DESCRIPTION OF THE DRAWINGS

The foregoing aspects and other features of the disclosed embodiments are explained in the following description, taken in connection with the accompanying drawings, wherein:

FIG. 1 is a schematic diagram of a communication device incorporating features of the disclosed embodiments;

FIG. 2A shows a device incorporating features of the disclosed embodiments in an open position;

FIG. 2B shows a device incorporating features of the disclosed embodiments in a closed position;

FIG. 3 shows a device incorporating features of the disclosed embodiments;

FIG. 4 shows a flow diagram of a method in accordance with an exemplary embodiment; and

FIG. 5 is a block diagram of one embodiment of a typical apparatus that may be used to practice the features of the disclosed embodiments.

### DETAILED DESCRIPTION OF THE EXEMPLARY EMBODIMENT(S)

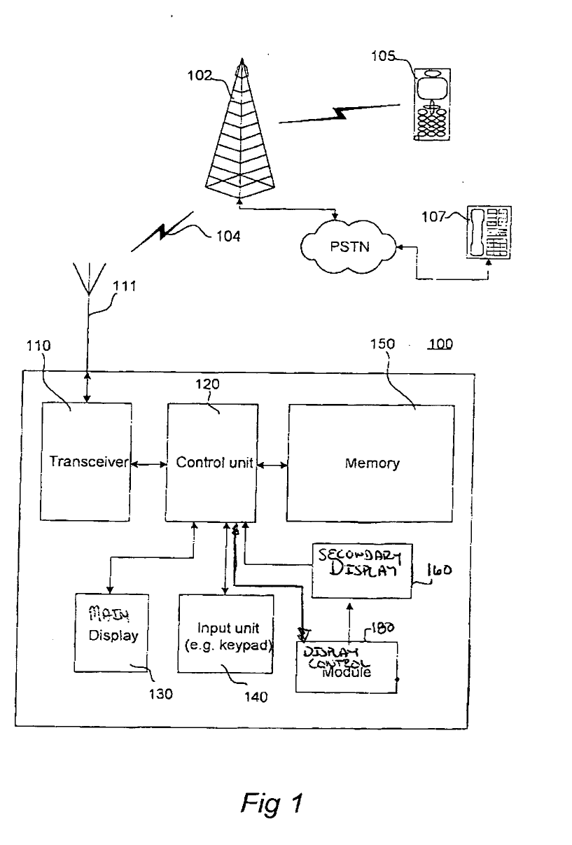

Referring to FIG. 1, one example of a device 100, such as a mobile communication device, incorporating features of the disclosed embodiments is shown. Although the disclosed embodiments will be described with reference to the drawings described below, it should be understood that the aspects of the invention could be embodied in many alternate forms of embodiments. In addition, any suitable size, shape or type of elements or materials could be used.

FIG. 1 is a schematic block diagram of a mobile telecommunication terminal 100 according to one embodiment. This system and the mobile communication terminal of FIG. 1 are used for ease of illustrating the disclosed embodiments and such illustrations are not intended to limit the aspects of the invention as claimed herein. A communication unit including a transceiver 110 is used for communicating with a base station 102 via an antenna 111. The base station 102 is in communication with other mobile telecommunication terminals 105 via a mobile communications network, and stationary terminals 107 via e.g. a public switched telephone network (PSTN).

Within communication device 100, a control unit 120 is coupled to the transceiver 110. The control unit 120 may comprise signal processing circuitry in order to process e.g. voice data and message data (e.g. SMS or MMS) from a user of the telecommunication terminal 100 and provide the transceiver 110 with the processed data for transmission to the base station 102. Likewise, the control unit 120 may comprise signal processing circuitry for processing data received from the other telecommunication terminals 105, 107 in order to provide the user of the mobile telecommunication terminal 100 with e.g. audio, image, video or message data. Alternatively (not shown) some or all of the signal processing functionality may be provided by specialized circuitry in the telecommunication terminal 100.

The control unit 120 is coupled to a main display 130 and a secondary display 160 for providing a user of the telecommunication terminal 100 with visual data regarding e.g. a specific call in progress, telecommunication numbers stored in the mobile telecommunication terminal 100, signal strength of the wireless communication link 104, messages received from other telecommunication terminals, etc. Although the term “main display” and “secondary display” are used herein to describe the aspects of the invention, the terms are not limiting and it should be understood that the respective displays can be of any suitable type and variety.

The control unit 120 is moreover coupled to an input unit 140, which may be in the form of a keyboard/keypad; an on-screen touch-sensitive keyboard; a navigation wheel or joystick for scrolling and selecting items, digits and/or characters shown on the display 130; and a microphone for receiving sound signals such as voice.

The control unit 120 can also be connected to a display control module 180, which can be used to control the secondary display 160. For ease of description, the term secondary display 160 can also include not only a display unit, but also user input devices and backlighting for keys and buttons.

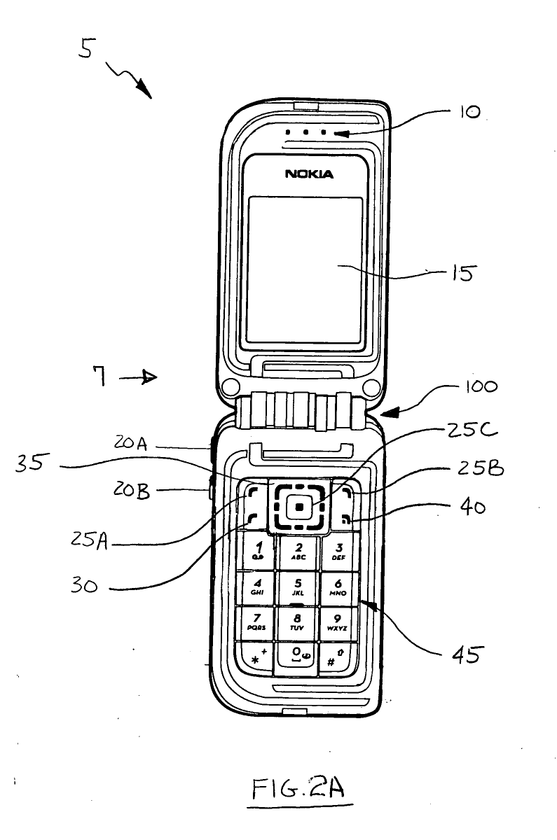

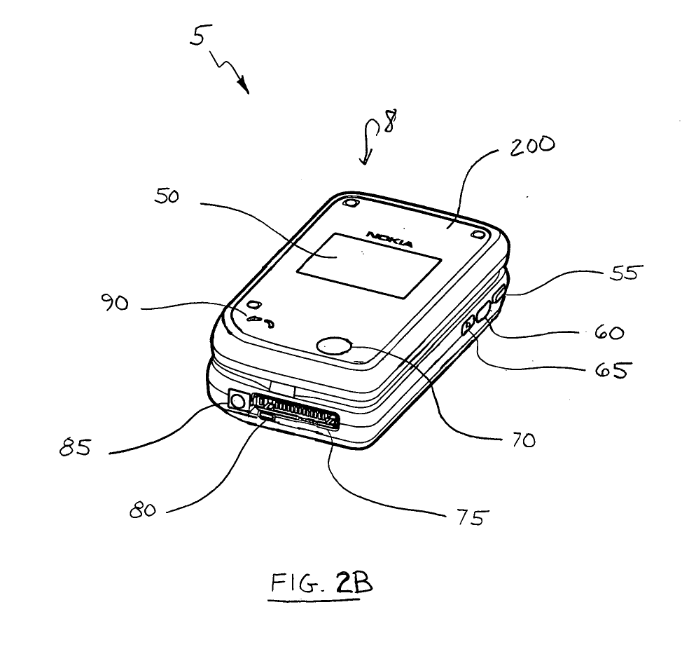

Referring to FIGS. 2A and 2B, one example of a device 5 incorporating features of the disclosed embodiments is illustrated. The device 5 illustrated in FIG. 1 is a flip style communication device, such as for example a mobile telephone, shown in an open configuration and having a hinge 100 that allows the phone to be folded into a closed position as can be seen in FIG. 2B. However, the embodiments disclosed herein may be applied to any mobile device having more than one user interface. For example, the device 5 could have sections that are slidable over each other. When the sections are moved or separated by sliding, one or more user interfaces may be exposed. An outer portion of a sliding section could include a secondary user interface as described herein.

As shown in FIG. 2A, the device 5 may also include a main user interface 7 having, for example, an earpiece or speaker 10 a main display screen 15, volume keys 20A, 20B, a left selection key 25A, a right selection key 25B, a middle selection key 25C, a four-way scroll key 35, a call key 30, an end key 40, a microphone 80 and a keypad 45. The main display screen 15 may be any suitable display such as a conventional display or a touch screen display. In alternate embodiments, the main user interface may have any suitable configuration. In one embodiment, the main user interface 7 may be the primary input of the device 5 and may be used for accessing all functions and features of the communication device 5.

Referring to FIG. 2B, the device 5 may also have a secondary user interface 8 located on the outer cover 200 of the device 5. In alternate embodiments, the secondary user interface can be located in any suitable area of the device 5. The secondary user interface 8 may include, for example, a display 50, a loudspeaker 90 and a push to talk key 55. In alternate embodiments, the secondary user interface may have any suitable configuration. The secondary user interface may also include, for example, a power key 65 (i.e. a separate on/off key), a camera 70, an infrared port 60, a charger port 85 and a connectivity port 75 for connecting the phone 5 with, for example, headsets, computers or any other suitable peripheral device. It should be understood that the device 5 may have any number of displays and keys located on the outer cover to which the embodiments disclosed herein are equally applicable.

A user of the device 5 may want to disable or turn off the display 50 and/or any keys or an illumination of the keys on the outer cover 200 of the device 5 (i.e. the secondary user interface). For example, the display 50 and keys, which may also including backlighting, may be turned off or disabled to prolong the charge on the battery of the device 5. A user may also want to prevent other people from seeing the device 5 in the dark so that the lights on the device 5 do not create a distraction, such as for example in a movie theater.

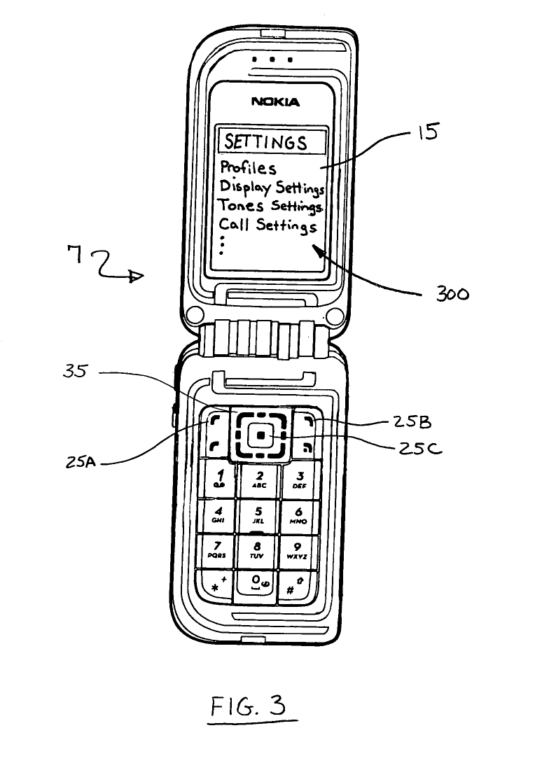

As shown in FIG. 3, the device 5 may have a settings feature that may be accessible through the main user interface 7. The settings feature may be accessed through, for example, a settings menu 300 displayed on the display 15. The settings menu may include selection or menu items such as user profiles, personal shortcuts, time and date settings, call settings, phone settings, display settings, tone settings and the like. Each of these menu items may have any number of sub-menu items. A user may scroll through the menu items using, for example, the scroll key 35 to highlight a desired menu item. The highlighted menu item may be selected using, for example, one of the selection keys 25A-25C. In alternate embodiments, where the main display screen is a touch enabled display, a user may use a stylus or other suitable pointing device for scrolling through and selecting the menu items. The sub-menu items may be selected in a substantially similar manner to that described above.

The device 5 may present a menu item for the settings of the display 8 that can be accessed using, for example, the scroll and selection keys 35, 25A-25C of the main user interface 7 or if the device is equipped with a touch screen the user may use a stylus or other pointing device. In alternate embodiments, the settings of the display 50 may also be accessed by pressing a user defined key or combination of keys (i.e. a shortcut). The sub-menu items for the settings of the display 50 may include brightness settings, aesthetic settings such as a clock configuration, or settings regarding the state of the display 50 such as on/off settings. There may also be on/off settings for activating and deactivating the keys or an illumination of the keys on the outer cover 200 of the device 5.

In one embodiment, the display 50, the keys and/or the illumination of keys, such as keys 55, 65, on the outer cover 200 of the phone may be turned off directly through a dedicated key without going through the menu selections of the device 5. The dedicated key may be located in any suitable area of the device 5 such as on the outer cover or within the main user interface 7.

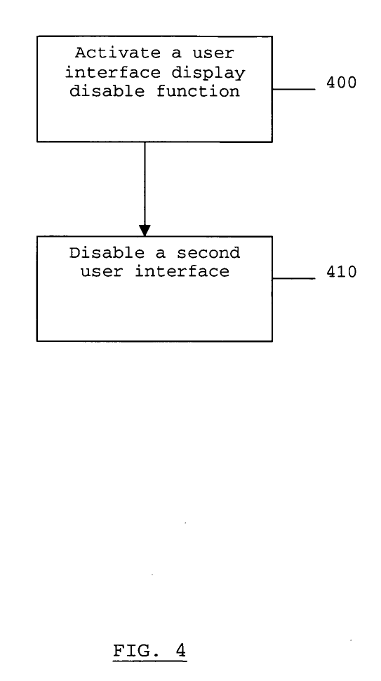

Using the scroll and selection keys 35, 25A-25C of the main user interface 7, a user may select a desired function, such as a disabling function, in the settings menu regarding the display 50 and/or the illumination of the keys 55, 60 on the outer cover 200 of the device 5 (FIG. 4, Block 400). For example, the user may select a menu item for disabling or turning off the display 50. The user may also select another menu item for turning off an illumination of, for example, the keys 55, 60 on the outer cover 200. The module 180, or such other suitable device of the device 100 of FIG. 1, may cause the display 50 and the illumination of the keys 55, 60 to be automatically disabled in response to the user selection (i.e. the instructions for turning off the secondary user interface) (FIG. 4, Block 410). In alternate embodiments, the display 50 and keys 55, 60 on the outer cover 200 may be turned off through a single menu item displayed on display 15. It should be understood that the secondary user interface 8 may be turned back on in a manner substantially similar to that described above by selecting a menu item corresponding to turning the display 50 and the illumination of the keys on.

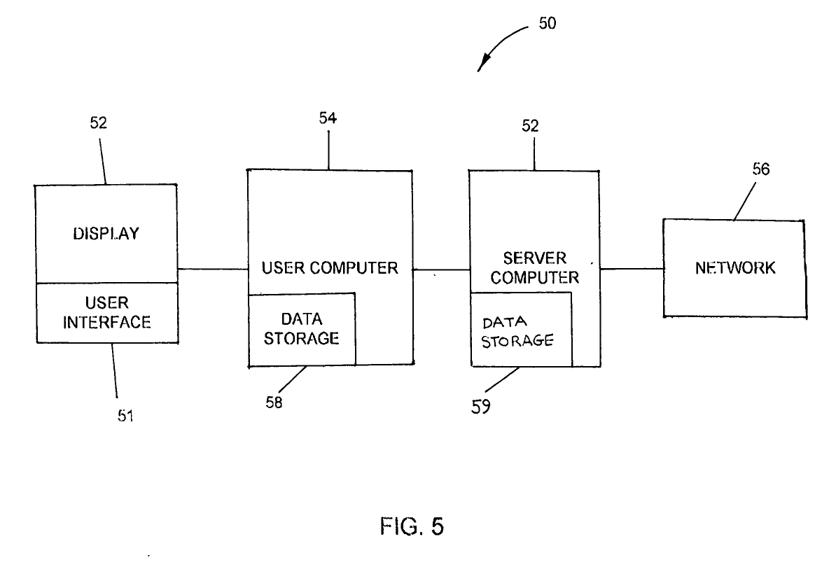

The disclosed embodiments may also include software and computer programs incorporating the process steps and instructions described above that are executed in different computers. FIG. 5 is a block diagram of one embodiment of a typical apparatus that may be used to practice the features of the disclosed embodiments. As shown, a computer system 50 may include computer system 52 linked to another computer system 54, such that the computers 52 and 54 are capable of sending information to each other and receiving information from each other. In one embodiment, computer system 52 could include a server computer adapted to communicate with a network 56, such as for example, a telecommunications network. Computer systems 52 and 54 can be linked together in any conventional manner including a modem, hard wire connection, or fiber optic link. Generally, information can be made available to both computer systems 52 and 54 using a communication protocol typically sent over a communication channel or through a dial-up connection on ISDN line. Computers 52 and 54 are generally adapted to utilize program storage devices embodying machine readable program source code which is adapted to cause the computers 52 and 54 to carry out and perform the method steps of the disclosed embodiments. The program storage devices may be devised, made and used as a component of a machine utilizing optics, magnetic properties and/or electronics to perform the procedures and methods of the disclosed embodiments. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 52 and 54 may also include a microprocessor for executing stored programs. Computers 52 and 54 may include a data storage device 58, 59 on its program storage device for the storage of information and data. The computer program or software incorporating the processes and method steps incorporating features of the disclosed embodiments may be stored in one or more computers 52 and 54 on an otherwise conventional program storage device. In one embodiment, computer 54, which can comprise the device 100 of FIG. 1, may include a user interface 51, and a display interface 52 from which features of the invention can be accessed. The user interface 51 and the display interface 52 can be adapted to allow the input of queries and commands to the computer 54, as well as present the results of the commands and queries.

The disclosed embodiments allow a secondary user interface, such as the display and any control buttons that are found on the outside cover of a foldable communications device to be disabled separately from the main user interface. This allows the cover user interface to remain inactive, even though the communications device is on.

It should also be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a first user interface and a second user interface; and
a processor connected to the first and second user interface, the processor being configured to disable at least one feature of the second user interface when a user interface deactivation input is received from the first user interface.

2. The apparatus of claim 1, wherein the apparatus is a mobile telephone comprising a flip phone.

4. The apparatus of claim 2, wherein the second user interface is located on an outside cover of the flip phone.

5. The apparatus of claim 1, wherein the processor is configured to turn off a display of the second user interface.

6. The apparatus of claim 1, wherein the processor is configured to disable at least one key of the second user interface.

7. The apparatus of claim 1, wherein the processor is configured to disable an illumination of at least one key of the second user interface.

8. The apparatus of claim 1, further comprising a key connected to the processor wherein activating and deactivating the key respectively disables and enables the at least one feature of the second user interface.

9. A method comprising:
activating a user interface display disable function on a first user interface of a device; and
disabling a second user interface of the device in response to the activation of the user interface disable function of the first user interface.

10. The method of claim 9, wherein the device is a mobile flip phone.

11. The method of claim 9, wherein disabling a second user interface includes turning off a display located on an outside cover of the device.

12. The method of claim 9, wherein disabling a second user interface includes disabling at least one key of the second user interface.

13. The method of claim 9, wherein disabling a second user interface includes disabling an illumination of at least one key of the second user interface.

14. The method of claim 9, wherein activating a user interface display disable function comprises pressing a combination of one or more keys on the first user interface.

15. The method of claim 9, wherein activating a user interface display disable function comprises selecting the user interface display disable function from a list of settings presented on a display of the first user interface.

16. The method of claim 9, further comprising activating and deactivating a key of the device for respectively disabling and enabling the second user interface.

17. A computer program product comprising:
a computer useable medium having computer readable code means embodied therein for causing a computer to disable a user interface of a device, the computer readable code means in the computer program product comprising:
computer readable code means for causing a computer to activate a user interface display disable function on a first user interface of the device; and
computer readable code means for causing a computer to disable a second user interface of the device in response to the activation of the user interface disable function of the first user interface.

18. The computer program product of claim 17, wherein the computer readable code means for causing a computer to disable a second user interface of the device includes computer readable code means for turning off a display located on an outside cover of the mobile device.

19. The computer program product of claim 17, wherein the computer readable code means for causing a computer to disable a second user interface of the device includes computer readable code means for disabling at least one key of the second user interface.

20. The computer program product of claim 17, wherein the computer readable code means for causing a computer to disable a second user interface of the device includes computer readable code means for disabling an illumination of at least one key of the second user interface.
